(19) United States
(12) Patent Application Publication
(10) Pub. No.: US 2010/0188241 A1
(43) Pub. Date: Jul. 29, 2010

(54) Current detection and precaution alarm device

(76) Inventor: Chieh-Te Chen, Yung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,300

(22) Filed: Jan. 23, 2009

(51) Int. Cl. G08B 21/00

(52) U.S. Cl. 340/664

(57) ABSTRACT

The present invention discloses a current detection and precaution alarm device consisting of a current sensing device, a current voltage converter, an alarm device, a selection adjusting button and an illumination device, and primarily used in a current loop of an electric power system for detecting a current signal of the current loop without changing any original power circuit of the electric power system or preparing an operating power supply. If the detected current quantity exceeds a default setting, sound and light alarm signals will be generated to remind users to reduce the power consumption and prevent a possible risk or a sudden power failure caused by a current overload, so as to improve the practical value and electric safety of a product.

### BACKGROUND OF THE INVENTION

1. Field of the Invention

The present invention relates to a current detection and precaution alarm device, and more particularly to a current detection and precaution alarm device having a current sensing device, a current voltage converter, an alarm device, a selection adjusting button and an illumination device, and primarily used in a current loop of an electric power system without changing any original power circuit of the electric power system or preparing an operating power supply. If the detected current quantity exceeds a default setting, sound and light alarm signals will be generated to remind users to reduce the power consumption, so as to prevent an accident or a sudden power failure caused by the current overload and improve the practical value and the electric safety of a product.

2. Description of the Related Art

In the installation of power circuits of a general conventional electric power system, the most commonly used method is to allocate a plurality of branch circuits in a master power supply distribution cabinet and install a fuseless circuit breaker for each branch circuit. If the current quantity of a load applied to the branch circuit exceeds an upper limit of the load, the fuseless circuit breaker will disconnect or interrupt the power. Although such arrangement can provide a temporary protection measure for the electric safety, yet a sudden power failure without any notice in advance will cause tremendous inconvenience to household and industrial users for household power consumptions or factory operations. If the electric quantity always exceeds a default upper limit of the load, then a high temperature of the electric wire will result and the overheated electric wire may cause a fire and an accident easily.

In our habits of consuming electricity, we generally plug increasingly more electric appliances to indoor power sockets, or even use a multiple-socket extension cord for the applications. As a result, the load of an electric power switch will increase continuously, but users usually neglect the possibility that the total current quantity consumed by all electric appliances has already exceeded the default upper limit of the load.

In view of the foregoing shortcomings of the prior art, the inventor of the present invention based on years of experience in the related industry to conduct extensive researches and experiments, and finally developed a current detection and precaution alarm device in accordance with the present invention to overcome the shortcomings of the prior art.

### SUMMARY OF THE INVENTION

Therefore, it is a primary objective of the present invention to provide a current detection and precaution alarm device, comprising a current sensing device, a current voltage converter, an alarm device, a selection adjusting button and an illumination device, and primarily used in a current loop of an electric power system, without changing any original power circuit of the electric power system or preparing an operating power supply. If the detected current quantity exceeds a default setting, sound and light alarm signals will be generated to remind users to reduce the power consumption and prevent a possible risk or a sudden power failure caused by a current overload, so as to improve the practical value and electric safety of a product. A feature of the present invention resides on that the current detection and precaution alarm device simply uses the electric power generated by the detecting electric wire hooked or penetrated to the current detection and precaution alarm device of the invention without requiring additional electric power. The electric power generated by the detecting electric wire can supply sufficient electric power for triggering and operating the alarm device.

Another feature of the present invention resides on that the selection adjusting button is provided for setting a default upper limit such as 75%˜95% of the detection current according to different specifications for the power consumption, such that the alarm device will be triggered if the detected current load value reaches the default threshold value.

A further feature of the present invention resides on that the electric power generated by the detecting electric wire hooked or penetrated to the current detection and precaution alarm device of the invention to supply the electric power required for the operation of the illumination device, without requiring an additional power supply. To make it easier for our examiner to understand the advantages, purposes and achieve the aforementioned objective, we use preferred embodiments and related drawings for the detailed description of the invention as follows.

With reference to FIG. 1 for an installation of the electric power system power circuit of the present invention, a master power supply box 10 allocates a plurality of branch circuit switches, and the total load of the master power supply box 10 is equal to the sum of a plurality of branch loads 11, 12, 13, 14, 15, 16. In the method of measuring the current quantity in accordance with the present invention, a current detection and precaution alarm device 2 is sheathed or hooked at an electric wire 17 pulled and extended from the master power supply box 10, such that the electric wire 17 is passed through the current detection and precaution alarm device 2 for performing a current load detection.

With reference to FIG. 2 for a current detection and precaution alarm device of the present invention, the current detection and precaution alarm device 2 comprises a current sensing device 21, a current voltage converter 22, an alarm device 23, a selection adjusting button 24 and an illumination device 25, wherein the current sensing device 21 is hooked or penetrated with a detecting electric wire for detecting a current signal of the electric wire; the current voltage converter 22 is provided for converting the current signal detected by the current sensing device 21 into a corresponding voltage level, and comparing the voltage level with a voltage level set by the default setting of a limit current, and if the detection value exceeds the default setting, a change of output will be produced; the alarm device 23 is provided for receiving the detection signal of the current voltage converter 22, and if the detection value exceeds the default setting, an alarm signal will be generated; the selection adjusting button 24 is provided for selecting and adjusting a predetermined threshold value of a load detection value; and the illumination device 25 uses the electric power generated by the detecting electric wire hooked or penetrated with the current sensing device 21 to supply the power required for the operation of the illumination device 25 and provide lights for the expected illumination.

### BRIEF DESCRIPTION OF THE DRAWINGS

FIG. 1 is a schematic view of a detection state of the present invention; and

FIG. 2 is a schematic view of a structure of the present invention.

### DETAILED DESCRIPTION OF THE PREFERRED EMBODIMENTS

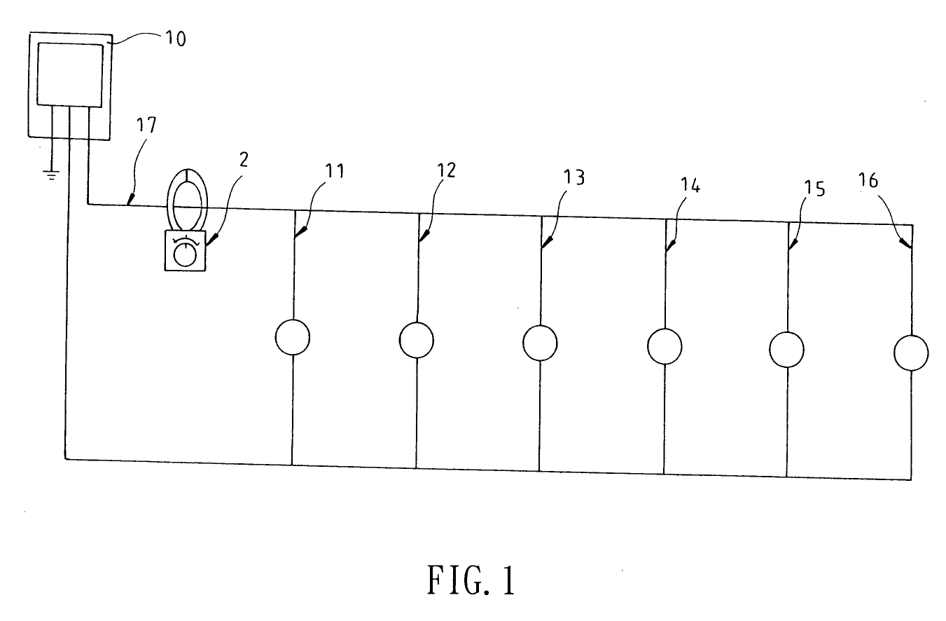

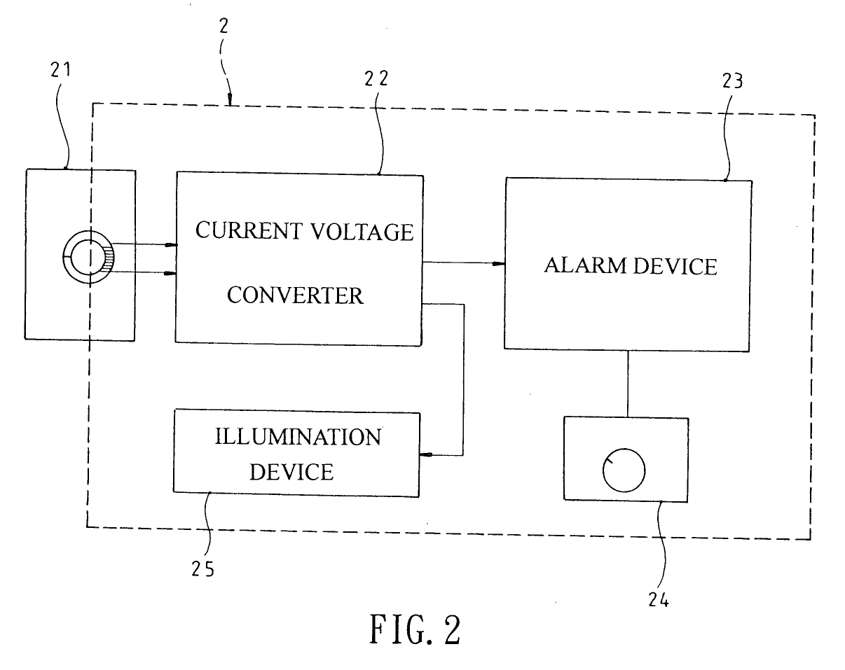

With reference to FIGS. 1 and 2 for each component of an assembly of the present invention, the current detection and precaution alarm device 2 uses an electric wire 17 pulled and extended from a master power supply box 10 which is hooked or penetrated to the current sensing device 21 for detecting a current load. If the current value of the electric wire 17 exceeds a predetermined threshold value, the current voltage converter 22 will produce an output change, and use the electric power generated by the detecting electric wire 17 hooked or penetrated with the current sensing device 21 for triggering an alarm device 23 to generate a “sound” or “light” alarm signal.

The alarm device of the invention is an audio device such as a buzzer and a speaker or a light emitting device such as a light bulb or a light emitting diode (LED).

While the invention has been described by means of specific embodiments, numerous modifications and variations with equivalent effects could be made thereto by those skilled in the art without departing from the scope and spirit of the invention set forth in the claims.

In summation of the description above, the present invention improves over the prior art, and complies with the requirements of patent application, and thus is duly filed for patent application.

What is claimed is:

1. A current detection and precaution alarm device, comprising: a current sensing device, a current voltage converter, an alarm device, a selection adjusting button and an illumination device, characterized in that the current sensing device is hooked or penetrated with a detecting electric wire for detecting a current signal of the electric wire; the current voltage converter is provided for converting the current signal sensed and detected by the current sensing device into a corresponding voltage level, comparing the voltage level with a voltage level corresponding to a default setting of a limit current, and producing an output change if the detection value exceeds the default setting; the alarm device is provided for receiving a detection signal of the current voltage converter and generating an alarm signal if the detection value exceeds the default setting; the selection adjusting button, is provided for selecting and adjusting a predetermined threshold value of the detection value of a load; and the illumination device is provided for using electric power generated by the detecting electric wire hooked or penetrated to the current sensing device to start operating the illumination device.

2. The current detection and precaution alarm device of claim 1, wherein the current sensing device is an open-ended sensing device.

3. The current detection and precaution alarm device of claim 1, wherein the current sensing device is a closed-ended sensing device.
